(19) United States
(12) Patent Application Publication
(10) Pub. No.: US 2007/0155375 A1
(43) Pub. Date: Jul. 5, 2007

(54) Cellular telecommunications system and methods of monitoring, control and communications

(76) Inventors: Thomas A. Kappel, Naperville, IL (US); Harold E. Asbridge JR., Rowlett, TX (US); Douglas Alan Gribben, Murphy, TX (US); Alexander Gordy, Highland Park, IL (US); Kevin Linehan, Rowlett, TX (US); Bobby Webb, Allen, TX (US)

Correspondence Address: Eric D. Cohen, 22nd Floor, 120 South Riverside Plaza, Chicago, IL, 60606-3945, US

(21) Appl. No.: 11/326,262

(22) Filed: Jan. 5, 2006

(51) Int. Cl. H04Q 7/20

(52) U.S. Cl. 455/422.1

(57) ABSTRACT

A cellular telecommunications system and methods of monitoring, control and communication within such a system. In one aspect redundancy is provided by a second mode of communication for control signals should the primary mode be unavailable. In one embodiment a secondary wireless network is provided in case of failure of a backhaul link. This allows the control of ancillary equipment in case of unavailability of the primary mode of communication. In another aspect continuity of telephony signals may be provided in a cellular communications system by utilising one or more wireless link between base stations to convey telephony signals normally conveyed via a backhaul link.

### FIELD OF THE INVENTION

This invention relates to a cellular telecommunications system and methods of monitoring, control and communication within such a system. More particularly, although not exclusively, there is disclosed a system and method including one or more secondary modes of communication providing redundancy for signals including status, alarm, control and telephony signals.

### BACKGROUND OF THE INVENTION

Cellular communication systems are increasingly being relied upon in place of traditional “copper” networks as primary communication channels. Network operators are demanding increased reliability and redundancy from cellular communication systems to cope with failure within the systems caused by failure of a network component, disaster etc.

If a single mode of communication with a base station is provided then failure of that mode of communication may render part of the network inoperable until it can be serviced. Further, if a base station cannot be controlled it may not be optimally configured to provide coverage in the case of a disaster and may not best utilize resources.

It would be desirable to provide a cellular telecommunications system having reduced down time and improved fault and disaster handling.

### EXEMPLARY EMBODIMENTS

A number of embodiments are described herein and the following embodiments are to be read as non-limiting exemplary embodiments only.

According to one exemplary embodiment there is provided a cellular telecommunications system providing backup in the event of unavailability of a first mode of communication. A second mode of communication may be provided to enable control of base station equipment in the event of failure of the primary mode of communication. The second mode of communication may also transport telephony signals if the first mode of communication is unavailable. The system may configure itself to optimize its operation as operating conditions change. Parts of the system may operate autonomously should communication with a central controller not be available.

According to another exemplary embodiment there is provided a cellular telecommunications system providing backup in the event of primary communications network unavailability including:
i a central controller;
ii at least one base station controller for controlling base station ancillary equipment;
iii a primary communications network for conveying control signals between the central controller and the at least one base station controller; and
iv a secondary wireless communications network enabling control signals to be communicated between the central controller and at least one base station controller the in the event of primary network unavailability.

According to another exemplary embodiment there is provided, for use in a cellular telecommunications system, a method of minimizing system downtime, comprising:
i conveying control signals between a central controller and a base station controller via a primary communications network; and
ii responsive to a detected unavailability of said primary communications network, conveying control signals between the central controller and the base station controller via a secondary wireless network.

According to another exemplary embodiment there is provided a cellular telecommunications system providing an alternate mode of communication in the event of unavailability of a primary mode of communication, including:
i a central controller;
ii a first base station having a first base station controller configured to control first base station ancillary equipment; and
iii a second base station having a second base station controller configured to control second base station ancillary equipment, wherein the first and second base station controllers are configured to:
   a. communicate in a first mode at least one of monitoring signals and control signals from the central controller to the first and second base station controllers; and
   b. respond to detected unavailability of said first mode of communicating by communicating in an alternate second mode of communicating at least a status of said first base station to the second base station controller, and wherein at least the second base station controller is structured to automatically reconfigure its operating parameters in dependence upon said status of said first base station.

According to another exemplary embodiment there is provided a cellular telecommunications system providing an alternate mode of communication in the event of unavailability of a primary mode of communication, including:
i a central controller;
ii a first base station having a first base station controller configured to control first base station equipment; and
iii a second base station having a second base station controller configured to control second base station equipment, wherein the first and second base station controllers are configured to:
   a. communicate in a first mode at least one of monitoring signals and control signals from the central controller to the first and second base station controllers; and
   b. respond to detected unavailability of said first mode of communicating by communicating in an alternate second mode of communicating at least a status of said first base station to the second base station controller and control signals from the second base station to the first base station.

According to a further exemplary embodiment there is provided, for use in a cellular telecommunications system, a method of distributed system control comprising:
i conveying control signals from a central controller to a first base station controller via a first mode of communication;
ii responsive to detected unavailability of the first mode of communication, communicating at least a status of the second base station controller to the first base station controller; and
iii the first base station controller reconfiguring its operating parameters in dependence upon the status of the second base station controller.

According to a further exemplary embodiment there is provided, for use in a cellular telecommunications system, a method of distributed system control comprising:
i providing a central controller and a first and second base station controller;
ii conveying control signals from the central controller to the first base station controller via a first mode of communication;
iii responsive to detected unavailability of the first mode of communication, communicating at least a status of the second base station controller to the first base station controller; and
iv the second base station controller reconfiguring its operating parameters in dependence upon control signals from the first base station controller.

According to another exemplary embodiment there is provided a cellular telecommunications system including:
i a central controller;
ii a plurality of base stations;
iii a first communications network for conveying telephony signals; and
iv a second wireless communications network providing wireless communication links between base stations wherein, upon unavailability of the first communications network, the system routes telephony signals via the second communications network.

According to another exemplary embodiment there is provided a method of providing continuity of telephony signals in a cellular telecommunications system including first and second base stations connected to a telephone network via backhaul links comprising:
i conveying telephony signals between the first base station and the telephone network via a backhaul link; and
ii in the event of unavailability of the backhaul link between the first base station and the telephone network conveying telephony signals for the first base station via the backhaul link to the second base station and a wireless link between the first and second base stations.

According to a still further exemplary embodiment there is provided a cellular telecommunications system providing backup power control in the event of primary network unavailability including:
i a central controller;
ii at least one base station controller for controlling base station equipment;
iii a primary communications network for conveying power control signals between the central controller and the at least one base station controller; and
iv a secondary wireless communications network enabling power control signals to be communicated between the central controller and the at least one base station controller in the event of primary network unavailability.

According to a yet further exemplary embodiment there is provided a base station controller for a cellular communications system including monitoring circuits for monitoring the status of site equipment and power supplies of a base station and control circuits for controlling the power consumption of site equipment wherein upon the monitoring circuits detecting an adverse event the control circuits reduce or reallocate the power consumption of site equipment.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a schematic diagram of a cellular communications system according to a first embodiment;

FIG. 2 shows a schematic view of an expanded cellular communications system;

FIG. 3 shows a block diagram of a base station controller and associated base station components; and

FIG. 4 shows a schematic diagram of a cellular communications system according to another embodiment.

### DESCRIPTION OF EMBODIMENTS OF THE INVENTION

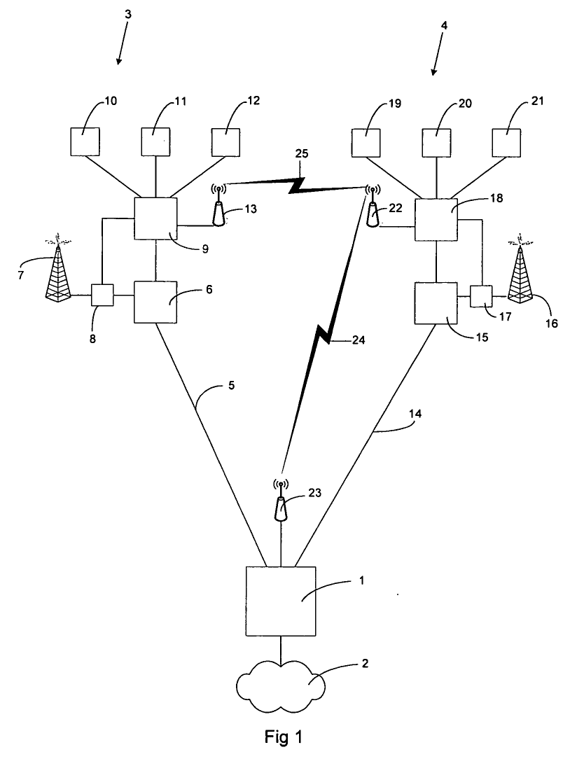

FIG. 1 shows a schematic diagram of a cellular communications system according to one embodiment. A central controller 1 conveys telephony signals between a public switched telephone network 2 and base stations 3 and 4. Central controller 1 is connected via a primary communications network in the form of a backhaul link 5 to a transport management unit 6 at base station 3. Backhaul link 5 may be a wireline link (typically a T1 or optical link) or a wireless link (typically a point to point microwave link). Telephony signals sent from central controller 1 to transport management unit 6 are normally sent to primary antenna system 7 for transmission (and telephony signals received by antenna system 7 are normally sent via transport management unit 6 to central controller 1). Typically in a cellular communications system the antenna will consist of a number of antenna arrays providing cell coverage. Controllable elements 8 may be provided in the feed path of antenna system 7 to adjust properties of the antenna beams. The controllable elements may include elements for adjusting down tilt, beam width or azimuth of antenna beams or amplifiers or other powered network elements. See US2004/0038714A1 for a general description of such a cellular communications system, the disclosure of which is incorporated by reference.

Control signals sent by central controller 1 to base station 3 are conveyed by transport management unit 6 to base station controller 9. Base station controller 9 may control power supplies, battery controllers and other ancillary equipment 10 to 12 such as ventilation fans, air conditioning units and so forth in accordance with control signals sent by central controller 1. Base station controller 9 may also control controllable elements 8 in accordance with control signals from central controller 1.

Base station controller 9 may monitor the status of controllable elements 8 and ancillary equipment 10-12 and convey monitoring and/or status and/or alarm signals via transport management unit 6 to central controller 1 via backhaul link 5. Base station controller 9 may periodically monitor controllable elements 8 and site ancillary equipment 10-12 and convey monitoring and/or status and/or alarm information to central controller 1 or may monitor the status of controllable elements 8 and site ancillary equipment 10-12 in response to a request received from central controller 1.

In this embodiment base station 4 may be similar to base station 3 including a transport management unit 15 having a primary communications network in the form of backhaul link 14 for communicating with central controller 1, a base station controller 18 for controlling and monitoring controllable elements 17 and ancillary equipment 19 to 21. Antenna system 16 communicates telephony signals from and to transport management unit 15. It will be appreciated that numerous such base stations may be provided in a typical cellular telecommunications system connected to a central controller via backhaul links and interconnected via a mesh of a secondary wireless communication links.

In this illustrative embodiment base station 3 includes a wireless transceiver 13 and base station 4 includes a wireless transceiver 22 providing a secondary wireless communications link 25 between base stations 3 and 4. Central controller 1 may include a wireless transceiver 23 providing a secondary wireless communications link 24 between central controller 1 and base station 4.

In the event of failure or unavailability of the primary mode of communication between central controller 1 and base stations 3 and 4 (e.g. the primary mode of communication over backhaul links 5 and 14) a secondary mode of communication may be provided. FIG. 1 shows an embodiment in which a separate wireless link provides the secondary mode of communication. Central controller 1 may include a transceiver 23 to communicate with transceiver 22 so that in the event of failure of backhaul link 14 central controller 1 may communicate via a secondary wireless communications link 24 with base station 4. If base station 3 is within range central controller 1 may communicate via transceiver 23 with transceiver 13 to communicate with base station 3. If base station 3 is not within range then base station 4 may convey information between base station 3 and central controller 1 via secondary wireless communications links 24 and 25 to communicate with central controller 1. Depending on the type of secondary wireless communications links 24 and 25 employed, transceiver 23 may be able to communicate directly with all transceivers 13 and 22 within the telecommunications system. Alternatively transceiver 23 may only be able to communicate with local transceivers with communications to more distant base stations being conveyed via a series of wireless links between base stations. In such a case each base station controller may maintain an IP address table so as to route communications most efficiently utilising the primary and secondary communication networks. Wherever available a backhaul link will usually be preferred due to its greater capacity and quality.

When a first mode of communication between central controller 1 and a base station fails, due to equipment failure, disaster etc, a second mode of communication may be employed. For example, if backhaul link 14 fails central controller 1 may send a request to base station 4 via wireless link 24 requesting a status report. Base station controller 18 may request a status report from ancillary equipment 17, 19, 20 and 21 and relay the status information back to central controller 1 via wireless link 24. Based on the status information received central controller 1 may send control information via wireless link 24 to base station controller 18 so that it may control ancillary equipment 17,19, 20 and 21 as appropriate in the circumstances. In the case of a disaster, equipment may be controlled so as to preserve power, provide coverage if adjacent base stations are inoperative etc. Control of the network from central controller 1 may be effected manually by an operator or under the control of an automated network management computer system.

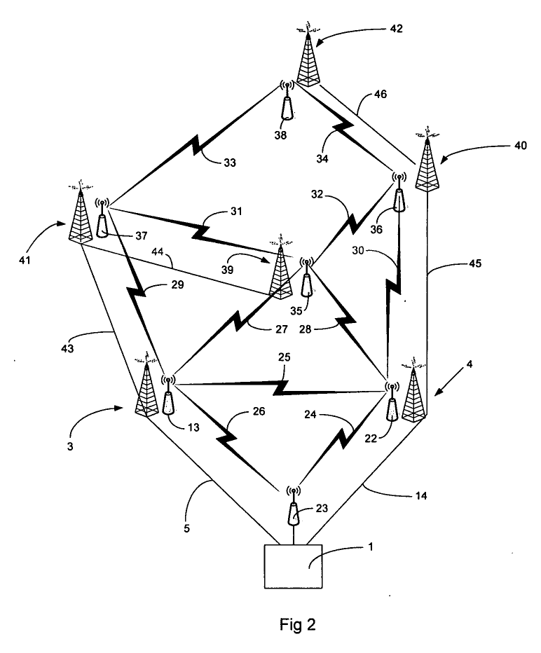

FIG. 2 shows an expanded network including several base stations 3, 4 and 39 to 42 connected via a primary communications network including backhaul links 5,14 and 43 to 46 to central controller 1. Only the primary and secondary antenna systems are shown for simplicity. Base stations 3, 4 and 39 to 42 and central controller 1 can also intercommunicate using transceivers 13, 22, 23 and 35 to 38 via wireless links 24 to 34. The topology of the links will depend upon the equipment employed and the geography.

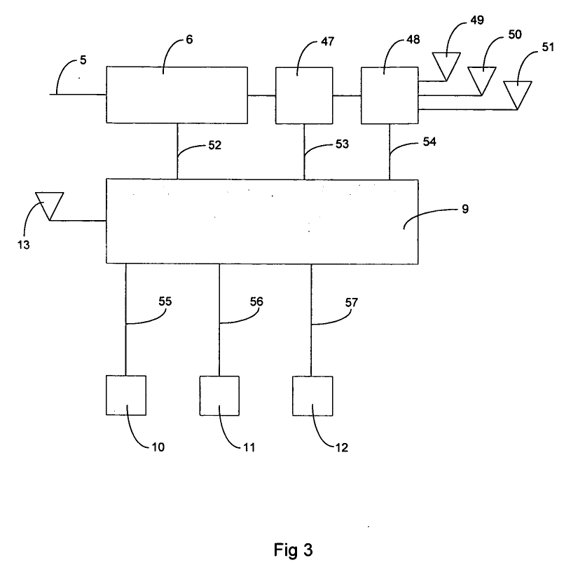

FIG. 3 shows a block diagram of a possible implementation including a base station controller 9 and its associated ancillary equipment and controllable elements. Telephony signals received by transport management unit 6 from backhaul link 5 are directed to controllable amplifier 47 and beam shaping network 48 for transmission by antennas 49 to 51. Control signals may be extracted and fed to base station controller 9 via data bus 52. Based on control signals received or on internally generated control signals base station controller 9 may control controllable amplifier 47 via bus 53 and may shape the antenna beams by adjusting controllable elements (typically phase shifters and/or power dividers) by control signals sent to beam shaping network 48. Ancillary equipment 10 to 12, such as power supplies, battery controllers, ventilation fans, air conditioning units etc may be monitored via buses 55 to 57 and their operation controlled by control signals sent via buses 55 to 57.

If an event results in backhaul link 14 being unavailable and some of base stations 2, 40 and 42 having impaired capability central controller 1 may communicate with base stations 4, 40 and 42 utilising the secondary wireless network (wireless links 24, 30 and 34). If base station 40 has impaired cell coverage (due to loss of power, antenna damage etc.) that information may be conveyed to central controller 1 via the secondary wireless network. Controller 1 may send control signals to base stations 4 and 42 to change their coverage to cover the cell normally covered by base station 40. This may be effected by adjusting elements within beam shaping networks associated with each antenna system to adjust down tilt and/or the beam width and/or azimuth to achieve the desired cell coverage within the system.

Should part or all of the system be affected by power outages central controller 1 may also monitor the status of ancillary equipment via either the primary or secondary modes of communication. Central controller 1 may configure the system to best utilise available power resources by reducing or reallocating power consumption of ancillary equipment or by reallocating cell coverage between the available base stations (i.e. increasing the cell size for base stations with good power resources and reducing the cell size the base stations with poor power resources). Central controller 1 may control the operation of ancillary equipment and controllable elements to optimise coverage and power conservation according to prescribed operational objectives (i.e. coverage, power conservation etc). This may include changing the power transmission levels for cells by controlling the amplification levels of controllable amplifiers.

In one embodiment local base station controllers may include control systems to autonomously control base station equipment should both the primary and secondary modes of communication fail. For example, if both backhaul links 5 and 14 fail and wireless links 24 and 26 fail (or if the base station is out of range) then base station controller 18 may communicate with base station controller 9 via a wireless link 25 to ascertain the status of base station 3. On the basis of this information base station controller 18 may reconfigure itself. For example, if adjacent base station 3 cannot maintain coverage of its cell then controller 18 may adjust the coverage of antenna system 16 to provide coverage by controlling controllable elements 17 to adjust the down tilt and/or azimuth and/or beam width of its antenna beams (e.g., adjust coverage, power consumption, etc.). Further, according to one embodiment, if controller 18 is a “master” base station controller it may provide control signals to base station controller 9 to control the operation of base station 3. It will be appreciated that this concept can be expanded to any number of surrounding base stations.

According to another embodiment a secondary mode of communication may also be utilised to convey telephony signals. If for example backhaul link 5 failed, telephony signals to be transmitted by base station 3 could be conveyed to base station 4 via backhaul link 14 and then forwarded via wireless link 25 to base station 3. In this case transport management unit 15 extracts telephony data for base station 3 and routes it to base station controller 18. Base station controller 18 conveys the telephony data for base station 3 via wireless link 25 to base station controller 9. Base station controller 9 supplies the telephony signals to transport management unit 6 which transmits the telephony signals via antenna system 7. Where the capacity of wireless link 25 is limited, calls may be prioritised for transmission (e.g. 911 calls). If the capacity of the wireless link 25 allows all calls to be rerouted then there may be rerouted in this manner.

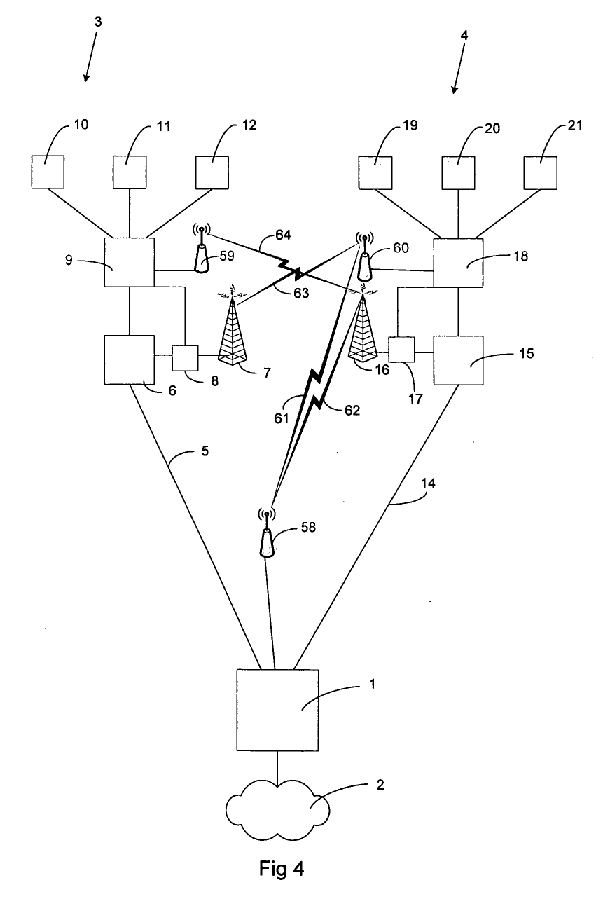

FIG. 4 shows a schematic diagram of a cellular communications system according to a preferred embodiment. The system of FIG. 4 is equivalent to the system of FIG. 1 apart from the secondary wireless communications links employed. Like integers have been given like numbers in FIG. 4 to those used in FIG. 1. Instead of peer-to-peer links the base stations 3 and 4 in this embodiment include transmitters 59 and 60 that transmit to the main base station antenna systems 7 and 16 respectively via wireless links 63 and 64. Central controller 1 communicates with base station 4 via transmissions from transceiver 58 to antenna system 16 via wireless link 62 and receives transmissions from transmitter 60 to transceiver 58 via wireless link 61. As before transceiver 58 may communicate with all base stations within its range and base station transmitters 59 and 60 may transmit to all base stations within range. This arrangement has the advantage that all received signals are routed through transport management units 6 and 15 rather than requiring routing through base station controllers 9 and 18. Apart from the different configuration of the secondary wireless links operation is otherwise as described in the above embodiments.

There is thus provided a system providing benefits including reduced down time and improved fault and disaster handling. The system reduces the demand for urgent maintenance by providing one or more secondary modes of communication for control signals. The system also allows resources to be managed and allocated so as to achieve desired system operation. Individual base station controllers may autonomously control ancillary site equipment if communication with a central controller is not available. The system further provides redundancy for telephony signals in the event of back haul unavailability.

While the present invention has been illustrated by the description of the embodiments thereof, and while the embodiments have been described in detail, it is not the intention to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A cellular telecommunications system providing backup in the event of primary communications network unavailability including:
i a central controller;
ii at least one base station controller for controlling base station ancillary equipment;
iii a primary communications network for conveying control signals between the central controller and the at least one base station controller; and
iv a secondary wireless communications network enabling control signals to be communicated between the central controller and the at least one base station controller in the event of primary network unavailability.

2. A system as claimed in claim 1 wherein in step iv control signals are communicated over part of the path from the central controller to the base station controller by the secondary wireless communications network and over part of the path by the primary communications network.

3. A system as claimed in claim 1 wherein in step iv control signals are communicated by the secondary wireless communications network only.

4. A system as claimed in claim 1 wherein the primary communications network is a backhaul link between a telephone network and a base station.

5. A system as claimed in claim 1 wherein the secondary wireless communications network is one or more radio link.

6. A system as claimed in claim 5 wherein communications via the secondary wireless communications network are transmitted from an auxiliary transmitter of one base station and received by the main antenna system of another base station.

7. A system as claimed in claim 1 comprising a plurality of base station controllers connected to the primary communications network which can intercommunicate with at least contiguous base station controllers via the secondary wireless communications network.

8. A system as claimed in claim 1 wherein each base station controller controls ancillary equipment selected from: power supplies, battery controllers, ventilation fans, air conditioning, powered network elements and communications amplifiers.

9. A system as claimed in claim 1 wherein upon detecting unavailability of the primary communications network the at least one base station controller sends information as to its current and reconfigures its operating parameters in response to control signals received via the secondary wireless network.

10. A system as claimed in claim 1 wherein the base station controller autonomously controls power to ancillary equipment in the case of unavailability of both the primary and secondary networks.

11. A cellular telecommunications system providing an alternate mode of communication in the event of unavailability of a primary mode of communication, including:
i a central controller;
ii a first base station having a first base station controller configured to control first base station ancillary equipment; and
iii a second base station having a second base station controller configured to control second base station ancillary equipment,
wherein the first and second base station controllers are configured to:
a. communicate in a first mode at least one of monitoring signals and control signals from the central controller to the first and second base station controllers; and
b. respond to detected unavailability of said first mode of communicating by communicating in an alternate second mode of communicating at least a status of said first base station to the second base station controller,
and wherein at least the second base station controller is structured to automatically reconfigure its operating parameters in dependence upon said status of said first base station.

12. A system as claimed in claim 11 wherein the primary mode of communication is via a backhaul link between a telephone network and the base stations.

13. A system as claimed in claim 11 wherein the second mode of communication is via a wireless link between the base stations.

14. A system as claimed in claim 11 wherein the ancillary equipment is selected from: power supplies, battery controllers, ventilation fans, air conditioning, powered network elements and communications amplifiers.

15. A system as claimed in claim 11 wherein the detected unavailability is due to power loss, power reduction, emergency or natural disaster.

16. A system as claimed in claim 11 wherein the second base station controller autonomously configures its parameters if the primary and alternate modes of communication are unavailable.

17. A system as claimed in claim 16 wherein the second base station controller autonomously configures its parameters based upon the cause of communication unavailability, the duration of unavailability and the status of ancillary equipment.

18. A method of providing continuity of telephony signals in a cellular telecommunications system including first and second base stations connected to a telephone network via backhaul links comprising:
i conveying telephony signals between the first base station and the telephone network via a backhaul link; and
ii in the event of unavailability of the backhaul link between the first base station and the telephone network conveying telephony signals for the first base station via the backhaul link to the second base station and a wireless link between the first and second base stations.

19. A method as claimed in claim 18 wherein each base station maintains a table of communication paths to connected base stations.

20. A method as claimed in claim 19 wherein the table is an IP-type table.

21. A method as claimed in claim 19 wherein the table records the current status of each communication path.

22. A method as claimed in claim 21 wherein, in the event of unavailability of the backhaul link between the first base station and the telephone network the first base station communicates telephony signals via a contiguous base station requiring the smallest number of wireless links to a backhaul link.

23. A method as claimed in claim 18 wherein the wireless link utilizes wireless data modems.

24. A method as claimed in claim 18 wherein certain types of telephony signals are prioritized.

25. A method as claimed in claim 24 wherein emergency calls are prioritized.
